(19) United States
(12) Patent Application Publication
(10) Pub. No.: US 2012/0041637 A1
(43) Pub. Date: Feb. 16, 2012

(54) ENGINE DIAGNOSTIC SYSTEM AND METHOD FOR CAPTURING DIAGNOSTIC DATA IN REAL-TIME

(75) Inventor: Dale C. Allemang, Farmington Hills, MI (US)

(73) Assignee: Detroit Diesel Corporation, Detroit, MI (US)

(21) Appl. No.: 12/853,400

(22) Filed: Aug. 10, 2010

(51) Int. Cl. G06F 19/00; G01M 17/00

(52) U.S. Cl. 701/31.5

(57) ABSTRACT

A diagnostic system for a vehicle that provides vehicle operational data during a fault code occurrence is disclosed. The diagnostic system includes an onboard diagnostics system and an engine control module. The onboard diagnostics system is configured for generating vehicle diagnostics codes when the vehicle operates outside predetermined operating parameters. The engine control module is operatively configured to monitor vehicle operational data for a plurality of vehicle subsystems. The onboard diagnostic system is configured to wirelessly transmit a vehicle diagnostic code when the vehicle operates outside of the predetermined operating parameters to a remote data storage location. The vehicle operational data is configured to be wirelessly transmitted from the engine control module to the remote data storage location.

### BACKGROUND

Sophisticated electronic control systems have been used in the heavy-duty vehicle industry to control various vehicle operations. In addition, heavy-duty vehicles are also provided with onboard electronic engine diagnostic (“OBEED”) systems that assist technicians in diagnosing problems that occur during operation of the vehicle. More specifically, when an electronically controlled engine system is found to be operating out of specification, the diagnostic OBEED system stores a fault code in an onboard computer. A warning light, such as a check engine light (“CEL”) or a stop engine light (“SEL”), is triggered to illuminate, indicating that a fault has occurred.

Traditionally, to determine the root cause of a fault codes, the stored fault codes must be accessed by a repair specialist. To accomplish this task, the vehicle must be brought to a repair facility where a diagnostic reader/computer is hard-wired to the OBEED system to download the previously recorded OBEED fault codes stored in the onboard computer. A technician correlates the OBEED fault code with a lookup table (either a manual or electronic lookup table) and determines which engine components may be associated with the fault code.

However, while the stored fault codes in the OBEED system indicates which engine component may have triggered the fault code, in some instances, technicians also need to review a “snapshot” or a “flight recording” of the engine operating systems contemporaneously with the fault code, to determine the root cause of the fault code. Currently, to obtain the snapshot or flight recording, the repair facility must put two technicians in the vehicle; one person driving the vehicle and another with a computer hardwired to the vehicle operating system and try to replicate the fault code occurrence, as well as capture and/or record the data related to the fault code occurrence event, in real time. This process can take anywhere from several hours to several days to replicate the code occurrence. Unfortunately, the vehicle is rendered idle during this process, in addition to any subsequent required repair time or wait time for necessary parts to arrive at the repair facility. Indeed, each day that the vehicle is idle translates to approximately $800-$1200 per day of revenue for its driver.

Accordingly, what is needed is a diagnostic tool that reduces diagnostic testing procedures and captures data regarding engine operating systems that is associated with diagnostic fault codes, in real time to reduce, if not eliminate, diagnostic testing.

### BRIEF DESCRIPTION OF THE DRAWINGS

Features and advantages of the disclosure will be apparent from the following detailed description and the appended claims, taken in conjunction with the accompanying drawings, in which:

FIG. 1 schematically illustrates an exemplary data communication scheme for a heavy duty vehicle; and

FIG. 2 is a flow chart illustrating operation of the data communication scheme illustrated in FIG. 1.

### DETAILED DESCRIPTION

Referring now to the discussion that follows and to the drawings, illustrative approaches to the disclosed systems and methods are described and shown in detail. Although the drawings represent some possible approaches, the drawings are not necessarily to scale and certain features may be exaggerated, removed, or partially sectioned to better illustrate and explain the disclosed device. Further, the descriptions set forth herein are not intended to be exhaustive or otherwise limit or restrict the claims to the precise forms and configurations shown in the drawings and disclosed in the following detailed description.

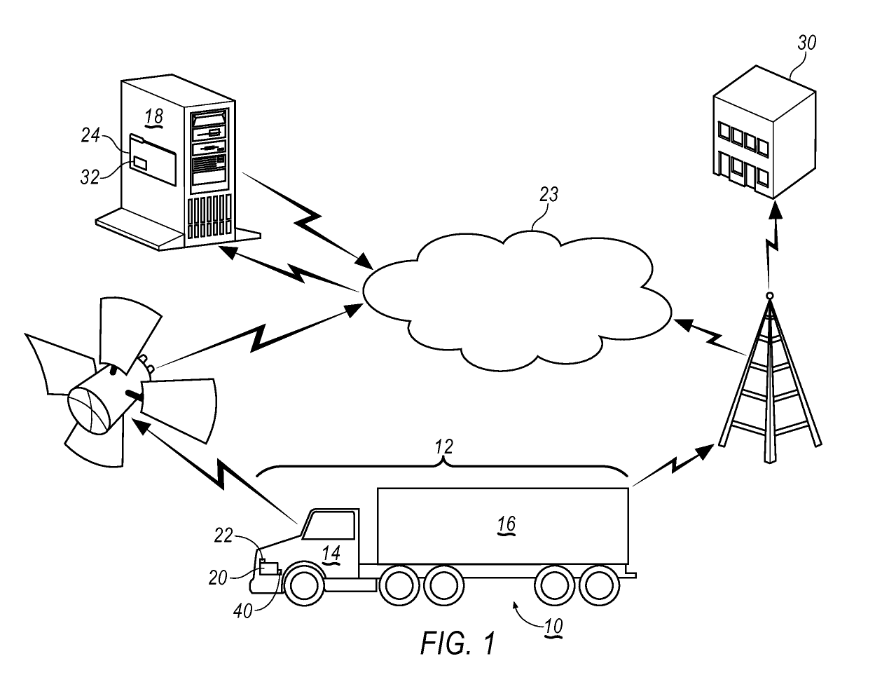

FIG. 1 schematically illustrates an exemplary data communication scheme 10 for use with a vehicle 12, such as a heavy duty vehicle that includes a tractor 14 and trailer 16. As will be explained in further detail below, vehicle 12 is wirelessly linked with a fleet management center server 18 using data communication scheme 10.

Vehicle 12 includes various electronic subsystems that independently control and/or monitor individual vehicle operations. The electronic subsystems are operatively connected together, via an engine control module 20. Engine control module 20 is configured to communicate with the various electronic subsystems, as well as controlling and monitoring the operational parameters of a vehicle engine and drive train, including, but not limited to at least the engine transmission and differential. Exemplary operational parameters include, but are not limited to, engine operating temperatures and pressures, as well as component commands, such as open, close, modulate or respond.

In an exemplary arrangement, as part of data communication scheme 10, engine control module 20 utilizes a data link 22 to transmit various status and/or control messages from engine control module 20. For example, data link 22 may be configured to transmit engine speed, oil temperature, accelerator pedal position, vehicle speed, and the like. In one exemplary arrangement, data link 22 conforms to SAE J1939 and SAE J1587 to provide various service, diagnostic, and control information to other engine systems, subsystems, and connected devices, as will be explained below in further detail.

In one aspect of the disclosure, data link 22 is used as part of an onboard electronic engine diagnostic (“OBEED”) system that is operatively connected to engine control module 20 to transmit event fault codes when engine control module 20 determines that an engine system is found to be operating out of a predefined specification. Traditionally, data link 22 has been hardwired to a diagnostic tool or an external computer to electronically transmit fault codes for the purpose of performing diagnostic testing to ascertain root causes of the event fault code. However, while fault codes are electronically stored in the engine control module 24, the engine operating parameters and/or the component commands at the time of event fault code are not traditionally captured.

In accordance with one aspect of the present disclosure, to reduce diagnostic testing required to replicate an event fault code and capture engine operating parameters and/or component commands during the event fault code occurrence, data link 22 of the present disclosure is configured to transmit engine operating parameters and component command information, at least during an event code occurrence. In one exemplary arrangement, data communication scheme 10 includes data link 22 being configured to wirelessly transmit engine operating parameters and component commands across a network 23 to a log file 24 in a remote fleet management center server 18. In one exemplary arrangement, the wireless transmission across network 23 may be performed either via a satellite 26 or a cellular tower 28 to server 18. Server 18 may be configured to transmit log file 24 to a pre-selected repair facility 30 upon a determination of an event code occurrence.

In accordance with a further aspect of the disclosure, to insure that engine operating parameter and/or component command data is available for a predetermined time before an event fault code has occurred, as well as just after an event fault code has occurred, data link 22 is also configured to perform a continuous capture of engine operational information to a ring buffer 32 within log file 24 disposed in remote server 18. More specifically, in the context of the present disclosure, continuous capture refers to the capture of a specific predetermined time duration of the engine operational information that when reached, automatically deletes the oldest information from log file 24 to make room for the newest information. In other words, data link 22 transmits a “snapshot” or “flight recording” of the engine operational information for a predetermined time period.

In addition to continuously capturing engine operating parameters and component commands to ring buffer 32, data communication scheme 10 also provides for engine control module 20 and data link 22 to be configured to wirelessly transmit over network 23 event fault codes upon an event fault code occurrence to server 18, rather than store the event fault codes in the OBEED system. When the event fault code is triggered, a message is sent to server 18, which is programmed to retrieve log file 24 of the engine operating parameters and component commands that correlates with the timing of the event fault code. In this manner, when an event fault code occurs, the information necessary to determine a root cause of the event fault code occurrence is automatically captured and wirelessly transmitted to log file 24, without any operator/driver or repair facility intervention.

In one configuration, ring buffer 32 is configured to capture engine operating parameters and component commands data for a predetermined time segment that is sufficient to provide the data prior to the fault code event occurring, as well as for a predetermined time segment after the fault code event. This information is essentially the same information that is traditionally captured by hardwiring the engine controller 20 to a diagnostic tool and driving vehicle 12 to duplicate the fault code event by a repair technician after the initial engine code event has occurred. However, because the engine operating information is captured in real-time and automatically correlated to the event fault code, time for diagnostic testing is significantly reduced and/or eliminated as this information may be electronically transmitted to log file 24 in server 18.

Moreover, with fault code event, engine operating parameters and component commands data transmitted and captured in log file 24, this collective data may then be accessed, either directly through a hardwire connection to server 18, or alternatively, remotely through a web portal operatively connected to server 18, and reviewed to determine the root cause of the event fault code. Identification of the root cause of the fault code event enables remote and timely development of a repair plan for vehicle 12. The repair plan may also include ordering any necessary parts for carrying out any necessary repairs. Log file 24 and the repair plan may also be compiled together into a repair package for transmission to a selected repair facility 30. For example, the repair package may be electronically transmitted to a desired repair facility 30 across network 23 via satellite 26 or cellular tower 28.

Because repair specialists may be able to access the repair package information stored on server 18 prior to vehicle 12 reaching repair facility 42, the repair specialists may employ a proactive service approach by identifying the service procedure and parts required for performing the repair, all before vehicle 12 arrives at the repair facility.

In accordance with another aspect of the disclosure, vehicle 12 may also configured with a telematics system 40 that tracks vehicle movement, driver hours, and motion and time related metrics. In one arrangement, telematics system 40 tracks an entire fleet of vehicles 12 such that the location of every vehicle 12 within the fleet is readily identifiable. In one exemplary arrangement, telematics system 40 is also supported by server 18 and receives information concerning each vehicle 12 via satellite 26 and/or cellular tower 28 over wireless network 23. When an event fault code occurs, log file 24 and the stored code event faults may be correlated with information from telematics system 40, to identify the closest available repair facility 30.

Use of communication data scheme 10 and creation of the repair package will eliminate the diagnostic time to identify the root cause of a code event occurrence, increase repair quality, and allow repair facility 30 to obtain parts prior to vehicle 12 arrival, thereby allowing vehicle 12 to move from an assessment to repair and back on the road in the shortest period of downtime.

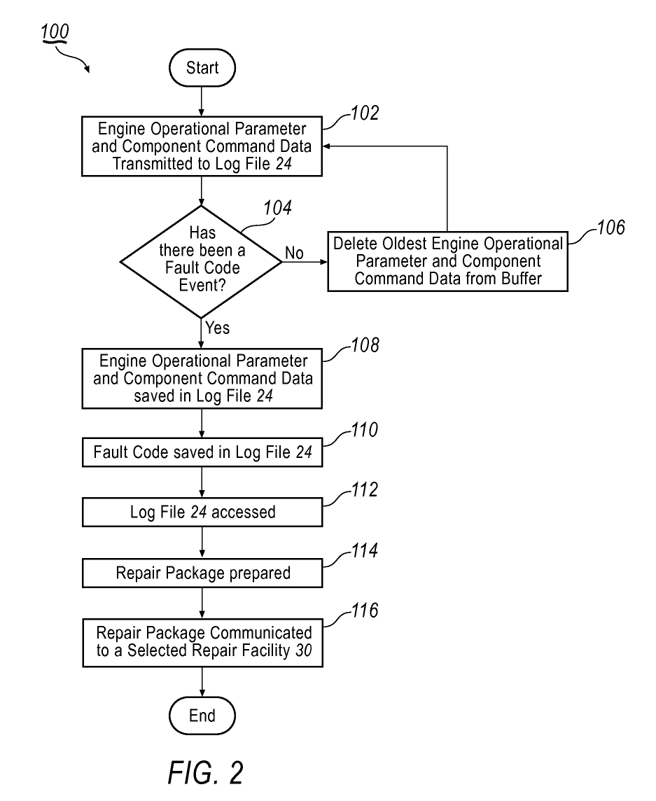

Referring to FIG. 2, an operation flow 100 of data communication system 10 will now be described. The exemplary operations in operation flow 100 may be performed periodically while vehicle 12 is being operated. While the exemplary operations are illustrated in a particular sequence in FIG. 2, it is understood that the exemplary operations may be performed in other sequences other than that shown in FIG. 2, depending upon the particular implantation.

Prior to operation flow 100, it is assumed that engine operational parameter and component command data has been gathered from one or more electronically controlled systems. Gathering the engine operational parameter and component command data involves requesting engine operational parameter and component command data from the one or more electronically controlled systems in real-time. The engine operational parameter and component command data is requested by engine control module 20.

Once engine operational parameter and component command data is collected, in step 102, the engine operational parameter and component command data is wirelessly transmitted via data link 22 to a log file 24 in a remote server 18. The transmission of engine operational parameter and component command data is continuously transmitted to ring buffer 32 in log file 24. The engine operational parameter and component command data is stored in ring buffer 32 for a predetermined time. The flow continues to step 104.

In step 104, a determination is made if there has been a fault code event occurrence. If no fault code event has been triggered, the flow proceeds to step 106. If a fault code event has been triggered, the flow proceeds to step 108.

In step 106, a portion of engine operational parameter and component command data is selectively deleted to make room for additional engine operational parameter and component command data to be temporarily stored in ring buffer 32. More specifically, the oldest engine operational parameter and component command data is deleted from ring buffer 32 such that newer engine operational parameter and component command data may be stored. The flow then returns to step 102.

In step 108, once a fault code event is triggered, engine operational parameter and component command data saved in log file 24 on server 18. In addition, in step 110, the fault code associated with the fault code event is also saved in log file 24 on server 18. Steps 108 and 110 may be performed simultaneously. The flow then proceeds to step 112.

In step 112, the log file 24 is then accessed by repair specialists. In one arrangement, log file 24 is made available via a web portal to repair specialist. In another arrangement, log file 24 is electronically transmitted to the repair specialist. Once the repair specialists access log file 24 and the triggering fault code, the repair specialists then determine the appropriate repair procedure, as well as any needed parts to repair vehicle 12 in step 114. The flow then proceeds to step 116.

In step 116, the repair specialists compile a repair package containing the log file 24 and the recommended repair procedure. This repair package is then communicated to an appropriate repair facility. In one embodiment, a telematics system 40 is employed that determines the location of vehicle 12. This location information is compared with various repair center locations so as to select the appropriate repair facility to direct vehicle 12. Selection of an appropriate repair facility may depend on vehicle location, availability of parts required for the repair at the repair facilities, and availability of labor at the repair facility. For example, while telematics system 40 may determine that a vehicle 12 is located physically closer to a first repair facility 42ₐ, a second repair facility 42_{b} may have the necessary parts required for the repair in stock, and have immediate labor availability to conduct the necessary repairs. In that instance, the repair package may be sent to the second repair facility 42_{b}. Once the repair has been made and vehicle is placed back in operation, flow 100 is reinitiated.

With regard to the processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

It is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The words used herein are words of description, not words of limitation. Those skilled in the art recognize that many modifications and variations are possible without departing from the scope and spirit of the invention as set forth in the appended claims.

We claim:

1. A diagnostic system for a vehicle that provides vehicle operational data during a fault code occurrence, comprising:
an onboard diagnostics system for generating vehicle diagnostics codes when the vehicle operates outside predetermined operating parameters;
an engine control module operatively configured to monitor vehicle operational data for a plurality of vehicle subsystems; and
a remote data storage location;
wherein the onboard diagnostic system is configured to wirelessly transmit a vehicle diagnostic code when the vehicle operates outside of the predetermined operating parameters to the remote data storage location; and
wherein the vehicle operational data is configured to be wirelessly transmitted from the engine control module to the remote data storage location.

2. The diagnostic system of claim 1, further comprising a data link that is operatively connected to the engine control module and wherein the data link is configured to wirelessly transmit the vehicle operational data.

3. The diagnostic system of claim 2, wherein the data link conforms to SAE J1939 or SAE J1587.

4. The diagnostic system of claim 1, wherein the vehicle operational data is continuously transmitted to the remote data storage location.

5. The diagnostic system of claim 4, wherein the remote data storage location further comprises a buffer for storing the vehicle operational data.

6. The diagnostic system of claim 5, wherein the buffer is configured to store the vehicle operational data for a predetermined time period.

7. The diagnostic system of claim 6, wherein the remote data storage location is configured to generate a log file when the onboard diagnostic system generates a vehicle diagnostic code; the log file comprising the vehicle diagnostic code and the vehicle operational data stored in the buffer.

8. The diagnostic system of claim 7, wherein the log file contains vehicle operational data for a predetermined time period before the vehicle diagnostic code was generated and for a predetermined time period after the vehicle diagnostic code was generated.

9. The diagnostic system of claim 7, further comprising a telematics system that tracks movement of the vehicle; wherein the remote data storage location is configured to correlate the log file with the telematics system.

10. A method of capturing data related to a fault code event during vehicle operation, comprising:
collecting vehicle operational data for a plurality of vehicle subsystems;
collecting a vehicle diagnostic code when the vehicle operates outside predetermined operating parameters; and
wirelessly transmitting the vehicle operational data and the vehicle diagnostic code to a remote data storage location.

11. The method of claim 10,
wherein the vehicle operational data occurs in connection with the vehicle moving.

12. The method of claim 10,
wherein the vehicle operational data is continuously transmitted to the remote data storage location.

13. The method of claim 12,
wherein the vehicle operational data is continuously transmitted to a buffer in the remote data storage location, wherein said buffer stores the vehicle operational data for a predetermined time period.

14. The method of claim 13, further comprising generating a log file when a vehicle diagnostic code is generated; the log file comprising the vehicle diagnostic code and the vehicle operational data stored in the buffer.

15. The method of claim 14, further comprising reviewing the log file and preparing a repair plan for the vehicle.

16. The method of claim 15, further comprising remotely determining the location of the vehicle and identifying a suitable repair facility for performing necessary repairs.

17. The method of claim 16, further comprising transmitting the repair plan to the identified repair facility.
